(19) United States
(12) Patent Application Publication
(10) Pub. No.: US 2013/0175371 A1
(43) Pub. Date: Jul. 11, 2013

(54) ELECTRIC SORTING BY MEANS OF CORONA DISCHARGE

(71) Applicants: Senada Schaack, Frankfurt am Main (DE); Nicola Benscheidt, Braunschweig (DE); Frank Borchers, Dortmund (DE); Matthias Berghahn, Moers (DE); Stefan Nordhoff, Recklinghausen (DE); Patrik Stenner, Hanau (DE)

(72) Inventors: Senada Schaack, Frankfurt am Main (DE); Nicola Benscheidt, Braunschweig (DE); Frank Borchers, Dortmund (DE); Matthias Berghahn, Moers (DE); Stefan Nordhoff, Recklinghausen (DE); Patrik Stenner, Hanau (DE)

(73) Assignees: STEAG POWER MINERALS GmbH, Dinslaken (DE); Evonik Degussa GmbH, Essen (DE)

(21) Appl. No.: 13/809,026

(22) PCT Filed: Jun. 30, 2011
(86) PCT No.: PCT/EP2011/003223

§ 371 Date: Mar. 28, 2013

(30) Foreign Application Priority Data
Jul. 8, 2010 (DE) 10 2010 026 445.8

(51) Int. Cl. B03C 7/02; B02C 23/08

(52) U.S. Cl. CPC B03C 7/02; B02C 23/08
USPC 241/24.14; 209/129

(57) ABSTRACT

A method for separating a particle mixture into a first and second fraction, the first fraction of particles having an electrical conductivity greater than the particles of the second fraction, by a) ionizing air to have the same polarity with a corona electrode; b) mixing the ionized air with a fluidized particle mixture containing two particle fractions with different electrical conductivities, to obtain a fluidized particle mixture ionized to have the same polarity; d) precipitating particles of the second fraction from the particle mixture on a collection electrode moving relative to the particle mixture, where the collection electrode is grounded or has an opposite charge to the corona electrode; e) removing particles adhered to the collection electrode as the second fraction; and f) obtaining the first fraction from particles of the particle mixture which do not adhere to the collection electrode.

The invention relates to a method for separating particle mixtures into a first fraction and into a second fraction, wherein the electrical conductivity of the particles of the first fraction is greater than the electrical conductivity of the second fraction.

The increasing scarcity of resources makes it economical to reclaim raw materials from waste. Here, rejected electronic equipment and electrical machines, so-called electrical scrap, is of particular interest. Electrical scrap occurs in large quantities because the service-life cycles of such products are comparatively short. Electrical conductors, such as copper and gold, and semiconductors, such as silicon and germanium, are sought after constituents of electrical scrap. These metals should be filtered out of non-conductive plastics.

As a result of the shifting energy paradigm, there will in future be more electrical scrap from photovoltaic modules and electrochemical cells. Photovoltaic modules serve to convert solar radiation into electrical energy. In addition to plastic they contain solar silicon, the production of which is energy intensive and so it should be reclaimed. Photovoltaic modules have a restricted service life because their efficiency decreases with age.

Electrochemical cells should be understood to mean arrangements which are able to convert chemical energy into electrical energy. Examples of these include primary batteries, secondary batteries (rechargeable batteries), double-layer capacitors and fuel cells. As a result of increasing electric mobility, an increased incidence is to be expected of electrical scrap from lithium-ion rechargeable batteries in particular. In addition to the electrical conductors copper, aluminum, graphite and carbon black, lithium-ion rechargeable batteries also contain non-conductive oxides of precious metals such as lithium, cobalt, manganese and nickel.

In order to reclaim the precious components of electrical scrap, a separation yielding unmixed parts as far as possible is necessary. These days, this is brought about manually, chemically by burning or acid treatment, or else by various electric sorting methods, which use the differing electrical conductivity of the materials as sorting criterion.

CN101623672A discusses the electric sorting of scrap from photovoltaic modules. To this end, the principle of contact charging is used: the material to be separated is introduced between two plates, charged with opposite polarity, of a plate capacitor. Electrically conductive particles such a silicon assume the polarity of the electrode upon contact therewith and, as a result thereof, are repelled from the electrode and accelerated in the direction of the counterelectrode. Upon impact on the counterelectrode, the conductive particles once again change their polarity and are flung back. A suitable arrangement of the plates makes it possible to remove the conductive particles, which are thrown to-and-fro between the capacitor plates, from the mixture. By contrast, the electrically non-conductive polymer constituents of the photovoltaic scrap stay stuck to the plates since charge separation occurs on their surfaces. The non-conductive fraction is consequently obtained by cleaning the capacitor plates.

In the case of appliances with contact charging, the requirement of a large contact surface should be considered to be disadvantageous (low throughput or high appliance costs). Lightning-like flashover as a result of impurities on the electrodes is also a significant disadvantage.

Corona discharge is an alternative effect suitable for separating particle fractions with differing electrical conductivity.

Here, the term corona discharge is used as conventional in the art. It should be understood to mean the ionization of a fluid surrounding a high-voltage electrical conductor, wherein the electric field strength emanating from the conductor may not be so great that sparking or an arc is caused. All particles situated in the corona field are charged with the same polarity during the ionization; this is independent of their electrical properties and usually with negative polarity in technical appliances. The particles are charged indirectly via the air molecules: these are initially negatively ionized as a result of the effect of the strongly inhomogeneous electric field between corona tip and collection electrode by virtue of free electrons and naturally occurring ions in the air being accelerated along the electric field lines and fragmenting a neutral air molecule into ions when impinging on said air molecule. The secondary ions produced as a result are further accelerated along the field lines and in turn impinge on further air molecules, ionizing the latter in the process. A large number of ionized air molecules are produced in a type of chain reaction. These are accelerated in the direction of the particles along the field lines, which are deformed as a result of the presence of the particles, then accumulate on the solid particles situated in the air and impart a negative charge on the latter.

The electrical conductor from which the electric field lines emanate is referred to as corona electrode in this context. In order to optimize the path of the electric field lines, corona electrodes are embodied with a great curvature, as a thin wire, a needle tip or, combining the two, with a barbed wire-like design. In the present case, the fluid is an air/particle mixture.

These days, so-called corona drum separators are used in electric sorting. These have a slide, on which the material to be sorted slides in the tangential direction toward a rotating drum. A barbed wire-like, electrically negatively charged corona electrode runs axially with respect to the drum at a small distance from the contact point. The drum serves as collection electrode; it is simultaneously grounded via a sliding contact serving as a scraper (carbon brush). An electric field is established between corona electrode and collection electrode, through which field the material to be separated glides from the slide in the direction of the drum. The corona electrode ionizes the air molecules and the particles to be separated electrically negatively in the tangential region. Upon impact on the drum, the non-conductive particles keep their charge while the conductive particles assume the polarity of the collection electrode. The conductive particles are consequently electromagnetically repelled by the collection electrode and collected in a first container. By contrast, the non-conductive particles electromagnetically adhere to the drum, are carried for approximately half a rotation, then scraped off by the carbon brush and finally collected in a second container.

Known corona drum separators only have a limited suitability for separating electrical scrap from lithium-ion batteries and photovoltaic modules: thus Li-ion batteries in particular have very dense packaging of different materials, and so the separation of these materials requires a fine-grained pulverization. However, conventional corona drum separators cannot process such fine-grained powder: the reason is considered to be the small particle size and the small particle weight: thus, a layer of air rotating with the drum is formed directly on the circumference of the drum; said layer of air drags along the particles and thus prevents an effective electrical contact with the collection drum.

U.S. Pat. No. 3,308,944 has disclosed an appliance for separating textile fibers by means of corona technology. The fibers are conveyed through an ionization path with the aid of an air blower. The fibers are separated on revolving electrode belts. A disadvantage of this method is that the fibers can become knotted into agglomerates before the application of conveying air. The separation accuracy is limited as a result thereof. A further disadvantage of this appliance is that the fibers are conveyed tangentially to the collection electrodes by means of the air flow, as a result of which—similarly to conventional corona drum separators—the fibers come into contact with layers of air dragged along by the collection electrode, which has an adverse effect on adherence and hence the separation accuracy.

DE102004010177B4 describes an appliance for combined ionization and fluidization of powder. To this end, corona electrodes are arranged in a fluid container above the porous fluid base. Pressurized air flows through the fluid base from below and fluidizes the layer of powder situated on the fluid base. The fluidized powder is then ionized by means of the corona electrodes.

EP1321197B1 describes a method and a device for coating rotating drums or moving belts. To this end, the drum or the belt is in sections immersed into a stationary fluidized bed within which particles ionized by means of corona discharge are fluidized and precipitate as coating on the belt or the drum. A separation function of the particles is not provided.

U.S. Pat. No. 7,626,602B2 likewise describes an appliance for coating moving belts. To this end, a fluid flow is routed past a corona electrode running transversely thereto and precipitated onto the belt to be coated. However, this appliance does not carry out a separation function.

In respect of this prior art, the underlying object of the present invention is to specify a method with the aid of which a fine-grained particle mixture, more particularly electrical scrap from photovoltaic modules or lithium-ion batteries, can be separated in an economic fashion.

This object is achieved by a method as claimed in claim 1.

Consequently, the subject matter of the invention is a method for separating particle mixtures into a first fraction and into a second fraction, wherein the electrical conductivity of the particles of the first fraction is greater than the electrical conductivity of the second fraction, comprising the following steps:
a) providing fluidized particle mixture containing two particle fractions with differing electrical conductivity;
b) ionizing air to have the same polarity by means of at least one corona electrode surrounded by air to be ionized;
c) mixing the ionized air with the fluidized particle mixture to obtain a fluidized particle mixture ionized to have the same polarity,
d) precipitating particles of the second fraction from the ionized, fluidized particle mixture on a collection electrode which is moving relative to the ionized, fluidized particle mixture and which is grounded or has an opposite charge to the corona electrode;
e) removing particles adhering to the collection electrode as second fraction;
f) obtaining the first fraction from particles of the ionized, fluidized particle mixture which do not adhere to the collection electrode.

The invention is based on the discovery that the corona discharge can only be used effectively for separating the particle mixture if the particle mixture can be kept in fluidized form throughout the whole separation process. This means that the fluidization of the particle mixture must be maintained throughout the whole process, i.e. from the provision onward, during the ionization thereof and up to the precipitation on the collection electrode. Initial fluidization during the provision alone is not enough since the particles run the risk of agglomerating prior to the ionization, which has an adverse affect on the ionizability and hence on the separation accuracy.

The particle mixture is fluidized by pneumatic application of pressurized air onto a layer of particles. A fluidized particle mixture is fluidized air, in which the particles are dispersed, i.e. isolated. This prevents the agglomeration of the particles. The mixture is activated for separation by ionizing the fluidized particle mixture. The mixture is ionized by ionized air molecules. To this end, the fluidized particle mixture should be mixed with the ionized air. It is possible for the fluidization of the particle mixture and the ionization of the air to be carried out separately. It is likewise possible for the air to be ionized directly in the fluidized particle mixture. In the latter case, the corona electrode is surrounded by the fluidized particle mixture. This allows a particularly effective ionization.

Apart from the movement of the individual particles in the swirling air, the fluidized particle mixture can be unmoving in space from a macroscopic point of view. In this respect, this is referred to as a stationary fluidized bed. However, the fluidized particle mixture can also move in space from a macroscopic point of view. If the fluidized particle mixture substantially moves only in the direction of the longitudinal extent thereof, this is a fluid flow which, in respect of its behavior, is comparable to the flow of gases. If the fluidized particle mixture overall moves at a speed that is significantly lower than the speed of the individual particles within the fluidized layer, this is referred to as a moving fluidized bed. It is not always possible to make a sharp distinction between moving fluidized bed and fluid flow.

The fluidized particles ionized to have the same polarity behave differently upon contact with the oppositely polarized collection electrode, depending on the electrical conductivity of said particles: non-conductive particles adhere to the collection electrode upon contact with the collection electrode as a result of the charge polarization on the particle surface. The electrically conductive particles assume the polarity of the collection electrode upon contact therewith and are accordingly repelled into the fluidized particle mixture by the collection electrode. Over time, the non-conductive particles from the fluidized mixture are enriched on the collection electrode while the fluidized particle mixture increasingly consists of the conductive fraction.

According to this principle, it is possible to realize different appliances for effectively separating the particle mixture which, in principle, can be embodied as follows:

In order to be able to design this separation process in a continuous fashion, it is necessary to move the collection electrode relative to the fluidized particle mixture in order to remove the non-conductive fraction continuously from the fluidized mixture. Once the fluidized particle mixture has been sufficiently depleted of non-conductive material, it is collected as conductive fraction and replaced by a fresh mixture. This can be brought about continuously by continuous withdrawal of the first fraction and addition of a fresh mixture, or quasi-continuously by sequential replacement of the fluidized particle mixture.

Different embodiments of the invention differ from one another in terms of the generation of the relative movement between the ionized, fluidized particle mixture and the collection electrode and in terms of the design of the corona electrode.

The relative movement between mixture and collection electrode can be implemented by virtue of the fact that the fluidized, ionized particle mixture stands still as stationary fluidized bed and the collection electrode moves through the fluidized, ionized particle mixture; for example as a revolving belt, a chain beset with plates or as a drum.

Kinematic reversal leads to a solution in which the ionized, fluidized particle mixture is, as a particle stream, directed at a stationary plate and moved over the latter. An intermediate solution consists of moving a quickly revolving belt as a collection electrode through a slowly moving fluidized bed.

In doing so, the collection electrode is immersed into the fluidized, ionized particle mixture or contacted on the interface.

The corona electrodes always have at least one tip pointing in the direction of the collection electrode in order to generate a high field strength in the direction of the collection electrode. The corona electrode can be embodied as wire, as “barbed wire” beset with tips or a plate beset with a plurality of tips. The corona electrode can be arranged along or transversely to the fluid flow/to the moving fluidized bed. It is possible for one or more corona electrodes to be provided.

Preferred embodiments of the invention emerge from the dependent claims and will be explained in more detail below.

In a preferred embodiment, the ionized, fluidized particle mixture is a fluid flow directed at a moving or unmoving collection electrode. In order to produce the fluid flow, an airflow force is applied to the fluidized particle mixture in the transport direction. The fluid flow can be directed at a single point on the collection electrode or can, transversely to the flow direction thereof, be moved over the collection electrode.

In a further preferred embodiment, the ionization takes place in a charge line through which the fluid flow is routed and in which the corona electrode extends such that the ionized fluid flow emerging from the charge line is directed at a collection electrode, that the particles rebounding from the collection electrode are collected as not-first fraction and that the particles adhering to the collection electrode are removed from the collection electrode as second fraction.

An advantage of this embodiment is that the mixture is positively guided along the corona electrode and the ionized particle beam is “shot” at the collection electrode. To this end, the fluidized particle mixture is conveyed with air through a charge line through which the corona electrode extends as well. The particle stream consequently flows directly along the corona electrode, and so there is intensive ionization of the particles without deviation of the particle stream. The beam emerging from the charge line should then be directed as frontally as possible onto the collection electrode so that the particles impinge on the surface of the collection electrode with a significant impulse. This is because the impulse of the particles may superpose possibly interfering flows on the surface of the collection electrode and moreover increases the repulsion effect on the electrically conductive particles.

In this embodiment, the charging of the particles is guaranteed by virtue of the fact that the air/particle mixture cannot, as a result of the shape of the charging pipe, avoid the corona charge, that the particles are present individually thanks to the fluidization and the charging with the same polarity and that the particles experience a reliable contact with the counterelectrode as a result of the corona charge and the airflow. These three effects are also decisive for separating the particle mixture.

The charge line is preferably a pipe made of an electrically insulating material, through which the corona electrode, which is embodied as a wire, extends in a coaxial fashion. This embodiment guarantees a reliable ionization of the particles in the particle stream. In this context, coaxial means that the tip of the corona electrode points in the direction of extent of the charge line. The corona electrode then corresponds to the main direction vector of the particle stream within the charge line in the region of the corona electrode.

In this embodiment, the particle mixture is provided in a tank. The tank is embodied as a fluid tank and, for this purpose, has a base made of an air-permeable material, through which pressurized air flows uniformly into the filled-in particle mixture. The pressurized air thus loosens the particles and disperses them in the emerging pressurized air. Fluidized thus, the particle mixture can be conveyed like a liquid by applying a flow force. Fluid tanks are known from the prior art, for example from DE10325040B3.

The pneumatic conveyance of the particle mixture from the tank into the charge pipe and on to the collection electrode is preferably brought about in such a way that inflowing pressurized air is injected through a tapering nozzle into a mixing chamber connected firstly to the charge line and secondly to a tank which provides the particle mixture, the flow cross section of which mixing chamber being greater than the opening cross section of the nozzle. This method makes use of the Bernoulli/Venturi effect for sucking up the particle mixture. The inflowing (clean) pressurized air experiences an increase in speed as a result of the cross-sectional taper in the nozzle, which results in a pressure drop. This negative pressure is used to suck the fluidized particle mixture into the mixing chamber from the tank so that it is mixed there with the pressurized air to form the particle stream. The conveying apparatus for applying an airflow force to the fluidized mixture then practically has the design of a water jet pump.

However, a disadvantage of the Venturi nozzle lies in the fact that the cross section of the nozzle gradually changes over time as a result of the abrasion such that the speed reduces as a result thereof and, as a result thereof, the amount of mixture collected also reduces. The cross section of the Venturi nozzle must therefore be monitored. Another solution, which also requires less air, is provided by the so-called dense-phase conveyance, in which powder is transported with the aid of a transmission vessel and pressurized air. A suitable pump for dense-phase conveyance is disclosed in DE202004021629U1.

In a similar embodiment of the invention, the charge line is a slit nozzle made of an electrically insulating material, over the cross section of which a wire-shaped corona electrode beset with tips extends. Compared to a round nozzle, such a slit nozzle enables a higher throughput. The slit nozzle is fed with mixture from a fluid tank by means of a Venturi nozzle.

An alternative embodiment of the invention consists of the fluid flow being routed through a slit nozzle made of electrically insulating material, in the surroundings of which at least one corona electrode in the form of a wire extending transversely with respect to the fluid flow is arranged such that the fluid flow is ionized when same emerges from the slit nozzle, in that the ionized fluid flow which has emerged from the slit nozzle is directed at a collection electrode, in that the particles rebounding from the collection electrode are collected as first fraction and in that the particles adhering to the collection electrode are removed from the collection electrode as second fraction. A high throughput is also advantageous in this case. An appliance suitable for the separation is described in U.S. Pat. No. 7,626,602B2.

In the simplest case, the collection electrode is embodied as a stationary baffle plate (e.g. a flat steel sheet). The method is carried out in a discontinuous fashion using such a collection electrode; the baffle plate is sprayed with the ionized particle stream until a layer of the non-conductive fraction has formed thereon. Then the particle stream is interrupted and the non-conductive fraction adhering to the baffle plate is removed. The particle stream is then sprayed onto the cleaned baffle plate again.

This method can be carried out in a continuous fashion by virtue of the collection electrode being embodied as a revolving belt. Then the particle stream is continuously sprayed onto the (metal) belt, for example in the region of the pull strand, and the second fraction is removed from said belt in the region of the return strand.

A continuously operating hybrid of baffle plate and belt is also feasible, in which a multiplicity of baffle plates are attached to a revolving chain. A revolving chain with baffle plates is an alternative to a belt, having the same technical effect. The baffle plates can preferably also be sprayed on both sides.

When designing any collection electrode, it is important that the particle stream does not impinge tangentially on the surface, as is the case in corona drum separators. Moreover, it is only possible to eliminate the negative effects of interfering flow effects in the case of moving collection electrodes if the particles have a significant impulse in the direction of the collection electrode; this is not the case in the case of a tangential angle of incidence of 180°. There is a better transfer of impulse if the angle between the surface of the collection electrode and the flow direction of the particle mixture is obtuse to orthogonal where possible. The electric field (and hence the separation accuracy) becomes ever stronger the smaller the distance is between the negative corona electrode and the positive plate electrode. The path between corona and collection electrodes should therefore be kept short. If the charge line is at an angle to the collection electrode, there are different path lengths for the particles as a result of the modified field lines, which are followed by the particles. An orthogonal alignment of charge line or nozzle with respect to the collection electrode is therefore ideal. However, the particle stream that has emerged from the charge line should at least be directed at the collection electrode in such a manner that the particle stream that has emerged from the charge line impinges on the surface of the collection electrode at an angle that differs from 180°.

An orthogonal alignment of charge line or nozzle and corona electrode with respect to the collection electrode appears ideal because the electric field lines and the flow paths of the particle stream run parallel to one another in this case.

In a particularly preferred embodiment, the ionized, fluidized particle mixture is embodied as a stationary fluidized bed. In order to generate a relative movement of the collection electrode thereto, said collection electrode is embodied as a rotating drum or a revolving belt, wherein the drum or the belt is, in sections, immersed into the fluidized bed or at least contacts the fluidized bed in the boundary region thereof and the electrically insulating fraction is removed from the belt or drum outside of the immersed region. An advantage of this embodiment is that a few installation components can be used to bring about an industry-relevant high throughput, which increases operational reliability compared to multiplying nozzle arrangements because a fluidized bed appliance makes do with a smaller number of moveable parts.

For cleaning purposes, a stationary fluidized bed is operated in a quasi-continuous fashion, i.e. the pneumatic loading of the stationary fluidized bed is interrupted intermittently and, during the interruption, the particles of the collapsed fluidized bed are collected as first fraction and replaced by a freshly provided mixture. Large amounts of particle mixture can be processed as a result of this cyclical separation and cleaning operation.

As an alternative to a stationary fluidized bed, provision can be made for a moving fluidized bed. In this case, the collection electrode is embodied as a rotating drum or a revolving belt, with the fluidized bed moving along a section of the drum or of the belt. This embodiment is particularly preferred because it enables a very large throughput as a result of the continuous mode of operation.

Insofar as gravity is insufficient for conveying the fluidized bed, it is possible to apply to the fluidized bed an additional airflow force in the conveyance direction.

However, it is simpler to produce the migratory motion of the fluidized bed by gravity. To this end, the fluidized bed moves through an inclined channel, at the upper end of which the mixture to be separated is provided and at the lower end of which the first fraction is collected, wherein the collection electrode is embodied as a revolving belt, which, in one section, travels through the channel in the same direction as or counter to the moving fluidized bed and which, outside of the section, is cleaned of adhering particles in order to obtain the second fraction. This embodiment constitutes an excellent compromise between amount of throughput and operational reliability.

By multiplying the channels and the belts, it is easily possible to increase further the amount of throughput. To this end, the fluidized bed is left to move through an inclined channel, at the upper end of which the mixture to be separated is provided and at the lower end of which the first fraction is collected, wherein the collection electrode is embodied as a revolving belt, which, in one section, travels through the channel transversely to the moving fluidized bed and which, outside of the section, is cleaned of adhering particles in order to obtain the second fraction.

The corona electrode should preferably have a negative electric charge in all embodiments, and the collection electrode should be correspondingly grounded. Better effects are achieved if the collection electrode is additionally connected to the positive terminal of a voltage source because this additionally increases the potential difference between corona electrode and collection electrode.

As mentioned previously, the electrically conductive particles rebound from the collection electrode while the non-conductive second fraction adheres thereto. In general, these particles can be removed by applying an impulse load on the collection electrode. The impulse load can be applied by tapping by means of a hammer, by shaking off by means of a vibrator, by blowing off by means of pressurized air or by brushing/scraping off by means of a scraper.

The separation accuracy can be increased by virtue of subjecting the mixture to a screening process prior to the pneumatic load being applied. The screening process preferably takes place in a screen, the low-frequency screening movement of which is superposed by an ultrasound oscillation in the range between 20 and 27 kHz. Tumbler screen machines with inductive ultrasound excitation, as known from e.g. DE202006009068U1, are particularly suitable for the screening step. Use is preferably made of screen plates with a mesh of approximately 80 μm. Using this, it is possible to achieve a high screen capacity of 1500 kg/h*m². The optimum mesh depends on the composition of the particle mixture.

The advantage of ultrasound screening consists of the fact that the mixture to be fluidized obtains a more uniform grain size. Accordingly, the upwardly restricted grain size—what passes through the screen—is transferred to the fluidization. The screen residues are not introduced into the fluidized bed. The screening away of larger particles prior to fluidization also improves the ionization of the particle mixture: this is because more air ions accumulate on the larger particles than on smaller particles. If the larger particles were not screened away, these would be favored during ionization. The ultrasound excitation prevents the formation of blocking grains, i.e. the blocking of the screening mesh with particles which are only insignificantly larger than the mesh.

An important aspect of a successful combination of screening and corona separation methods is that both steps are strictly separated. It is not expedient to unify both steps structurally by virtue of, for example, simultaneously using the screen plate as collection electrode. Trials have shown that this promotes the formation of blocking grains and makes cleaning the screen significantly more difficult. As a result of the electrostatic forces, the less conductive particles adhere so strongly to the screen plate that the latter blocks quickly; hence a continuous mode of operation is hardly possible with such an appliance. The appliance presented in US2004/0035758A1 with a charged screen should inasmuch be rejected.

In principle, the method according to the invention is suitable for separating any particle mixture having particle fractions with different electrical conductivities. It is self-evident that a precondition for successfully carrying out the separation method according to the invention lies in the fluidizability of the mixture to be separated. This is given below a particle size of 100 μm. In particular, the method can be advantageously used if the screened fraction is the fine fraction and the fraction to be removed has a lower density than the screened fraction and vice versa (if the screened fraction is the rough fraction and the fraction to be removed has a higher density).

The present method was found to be particularly suitable for separating pulverized electrical scrap. In order to bring electrical scrap into a fluidizable form which satisfies the parameters described above, the electrical scrap can be broken by conventional crushers and subsequently ground in conventional grinders. The grain size of the ground electrical scrap should not exceed 100 μm.

Consequently, the subject matter of the invention also relates to a method for separating electrical scrap, comprising the following steps:
a) providing electrical scrap;
b) grinding the electrical scrap to a grain size of less than 100 μm in order to obtain pulverized electrical scrap;
c) pneumatic loading of the pulverized electrical scrap in order to obtain a fluidized particle mixture;
d) carrying out a separation method as described above.

The first fraction of pulverized electrical scrap will consist of electrical conductors and/or semiconductors. These can be metals, such as e.g. Fe, Cu, Al, Ag, Au, or semi-metals such as e.g. Si. Carbon black or graphite also occurs in the electrical scrap as electrical conductors.

The second fraction of pulverized electrical scrap will consist of electrical non-conductors. These are plastics, glasses or ceramics, in particular metal oxides.

It should be clarified here that the terms “electrical conductor” and “electrical non-conductor” should not be understood in the strictest sense of the word. Insulators of course also conduct electric current to a very small extent. What is decisive for the success according to the invention is that the particles of the first fraction have a higher conductivity than the particles of the second fraction. When an electrical non-conductor is referred to here, it should accordingly be understood to mean the fraction which, within the particle mixture, has a lower conductivity than the remaining particles.

To the extent that the electrical scrap consists of used photovoltaic elements, the first fraction will comprise solar silicon while the second fraction will substantially be made of plastics. The invention has an outstanding suitability for separating ground photovoltaic modules.

The invention is just as suitable for separating ground electrodes from electrochemical cells, in particular from lithium-ion batteries.

To the extent that the electrical scrap consists of used-up electrodes from lithium-ion batteries, the first fraction will comprise aluminum, copper, graphite and carbon black while the second fraction will comprise precious metal oxides and plastic.

Incidentally, within the meaning of the invention, the particle mixture can also have more than two particle fractions that differ in terms of their electrical conductivity.

In such cases, it may be necessary to carry out the separation process in a number of stages: provided that the first or second fraction is not yet homogeneous enough, the respective fraction can be subjected to a further separation step in order, ultimately, to obtain a third and fourth unmixed fraction.

By way of example, the just described first fraction of Li-ion battery scrap can thus, in a second step, be separated into aluminum and copper on the one hand and graphite and carbon black on the other hand. In a third and a fourth step, the aluminum is then separated from the copper and the graphite is separated from the carbon black, respectively. The decisive separation criteria are the differing electrical conductivities and the density of the particles.

There will also be a need to proceed in a similar manner if the scrap from photovoltaic modules also contains metallic connection lines (contacts) made of copper in addition to the solar silicon and plastic.

To the extent that the electrical conductivities of the fractions obtained in the mixture are situated far enough apart in a suitable fashion—for example as non-conductor, semiconductor, conductor—the separation into three fractions can also occur in a single step: this is because in this case the semiconductors like the non-conductive fraction adhere to the collection electrode, but with a lower adhesion force. Different forces are consequently required to remove the non-conductive fraction and the semiconductive fraction. In order to clean in a selective fashion, it is possible, for example, for a drum-shaped collection electrode to revolve with a specific rotational speed such that the semiconductors are flung away again from the collection electrode as a result of the centrifugal forces, while the non-conductors however continue to adhere and are only removed from the collection electrode by a scraper. In this case, three fractions would have to be collected: a first fraction of conductors, which are immediately repelled by the collection electrode, a second fraction of non-conductors, which are removed from the collection electrode by the scraper, and a third fraction of semiconductors, which are flung away from the collection electrode again after a brief adherence thereto.

Alternatively, the revolving collection electrode can be successively cleaned by cleaning blowers or suction nozzles with different strengths.

The subject matter of the invention also relates to an appliance for separating, according to the invention, particle mixtures into a first fraction and into a second fraction, wherein the electrical conductivity of the particles of the first fraction is greater than the electrical conductivity of the second fraction.

Such an appliance has the following design features:
a) at least one inclined channel with an air-permeable base to which pressurized air can be applied and which is provided with a multiplicity of corona electrodes,
b) a metering apparatus arranged at the upper end of the channel for supplying particle mixture to the channel,
c) a collector for collecting the first fraction, arranged at the lower end of the channel,
d) at least one revolving runner which runs in the channel in sections,
e) and a scraper arranged on the runner outside of the channel, for scraping off particles adhering to the runner as second fraction.

The runner is understood as a revolving collection electrode, which can be embodied as a belt, as a chain beset with plates or as a rotating drum.

The particular advantage of such an appliance should be seen in the fact that it enables the separation of very fine particle mixtures. Conventional corona drum separators are not able to process particles with a fineness of less than 100 μm. As a result of this, the appliance according to the invention can also separate electrical scrap which requires fine pulverization.

The subject matter of the invention consequently is also the use of such an appliance for separating particle mixtures with a particle size of under 100 μm.

In a particularly preferred embodiment of the appliance, the revolving belt runs up the channel along the channel. This appliance uses gravity for moving the fluidized bed and is therefore particularly operationally reliable.

The capability of this appliance can be increased by a multiplicity of runners which run transversely through the channel and are respectively embodied as a belt, by at least one revolving cleaning belt which runs parallel to the channel, and by virtue of the fact that scrapers are provided in the crossing region of cleaning belt and runners, which scrapers clean off particles adhering to the runners as second fraction and supply said particles to the cleaning belt to be transported away.

Continuous cleaning of the insulating layer away from the collection electrode is very important for the separation function because this ensures a strong electric field and an uninterrupted ion flow in the corona field. Both are mandatory for ensuring a reliable separation operation on an industrial scale.

Further embodiments of the invention and the features thereof now emerge from the following detailed description of a few particularly preferred exemplary embodiments. In this respect:

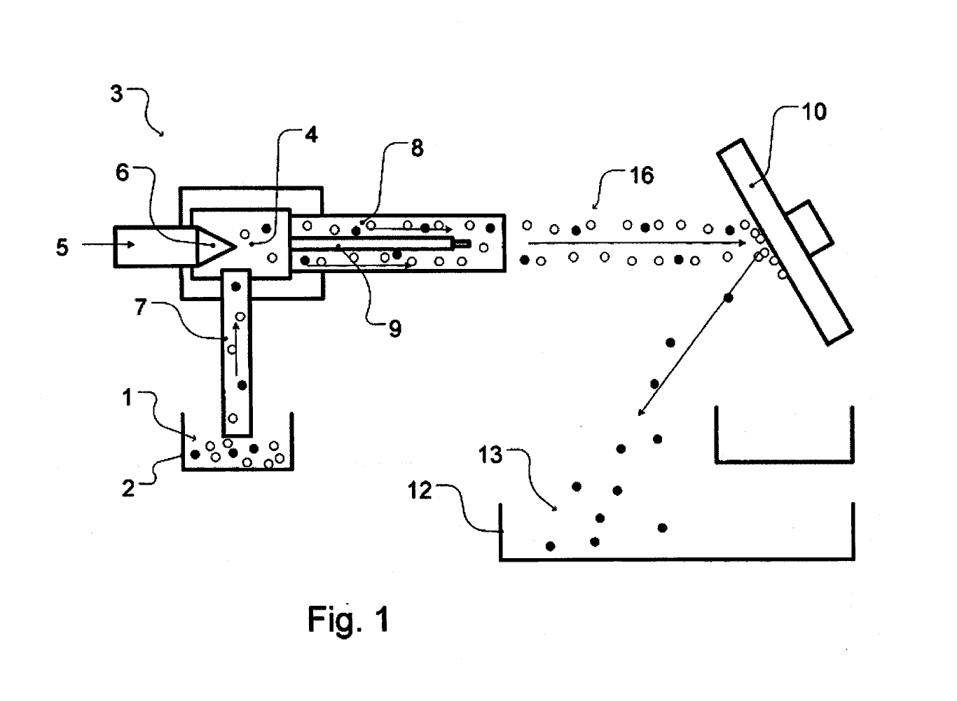

FIG. 1 shows a schematic diagram of spraying a baffle plate and collecting a first fraction;

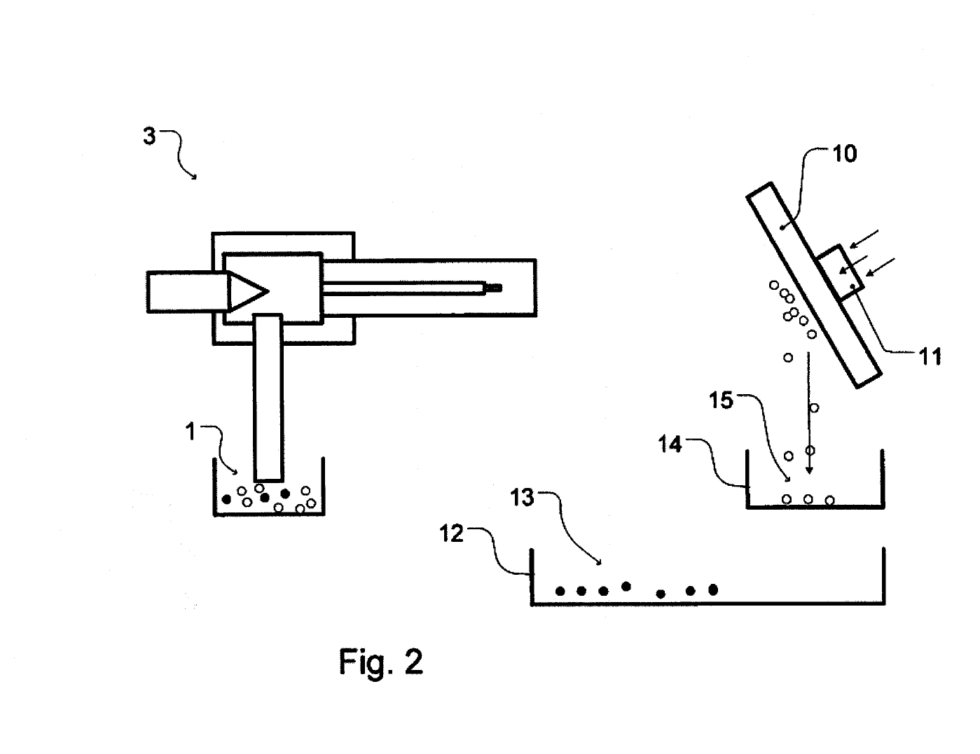

FIG. 2 shows a schematic diagram of removing a second fraction;

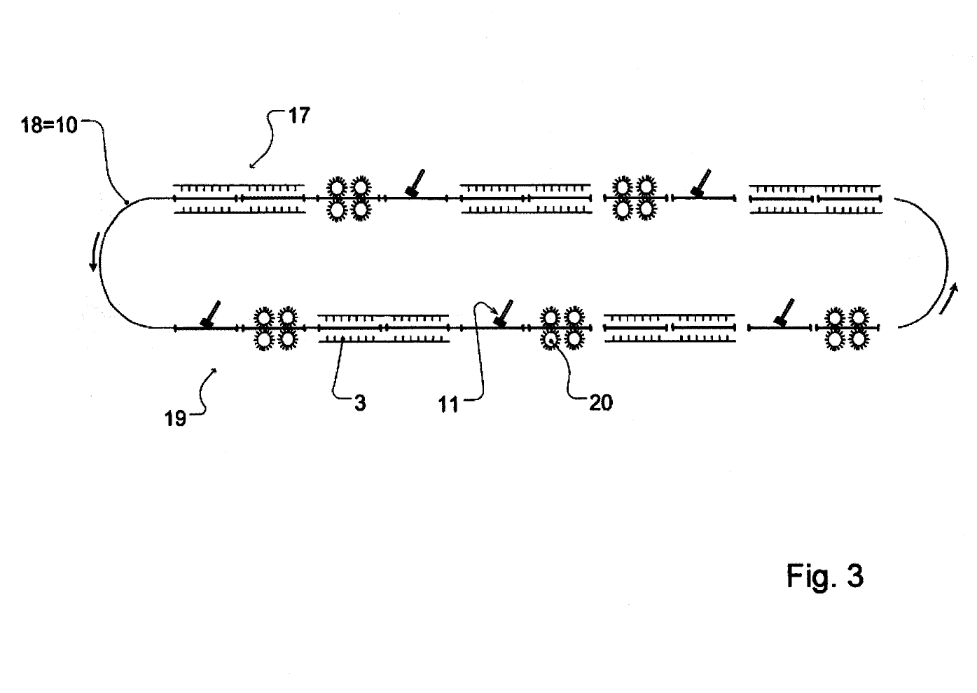

FIG. 3 shows a separation appliance (schematically) with a multiplicity of spraying and cleaning stations;

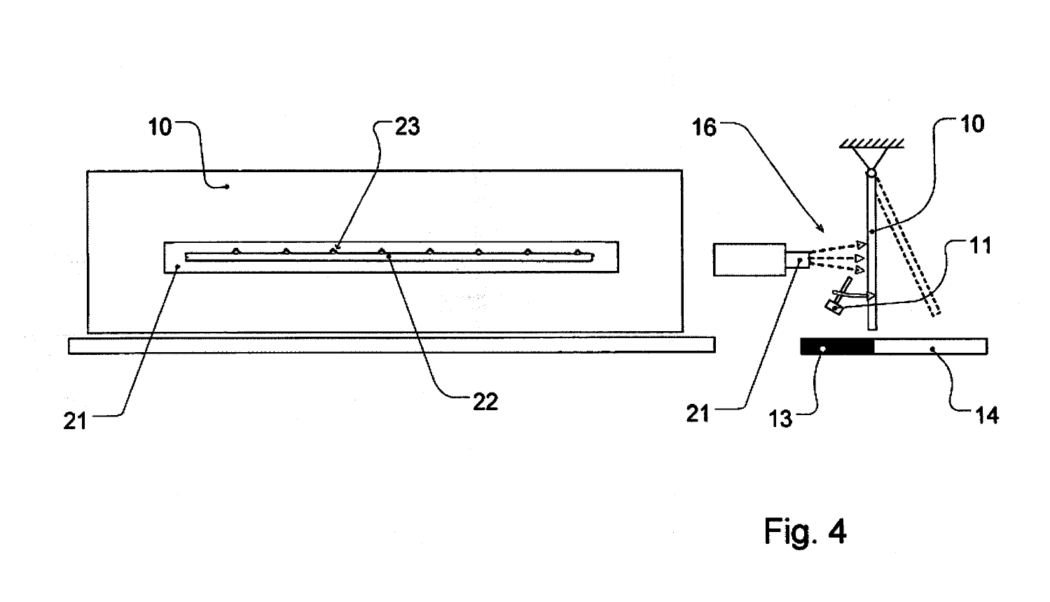

FIG. 4 shows a schematic diagram of a separation appliance with a slit nozzle and wire-shaped corona electrode and plate-shaped collection electrode;

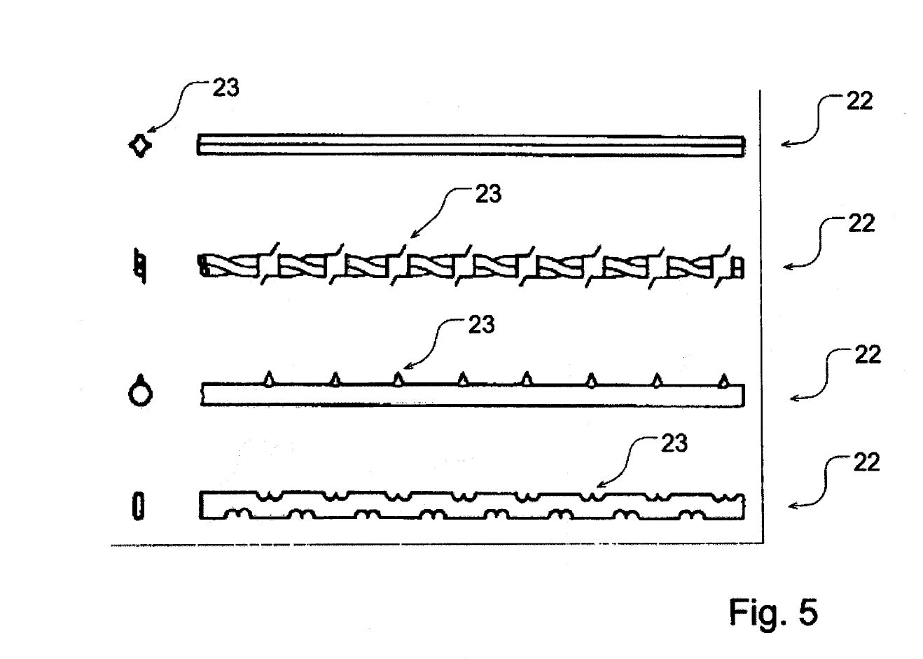

FIG. 5 shows embodiments of corona electrodes;

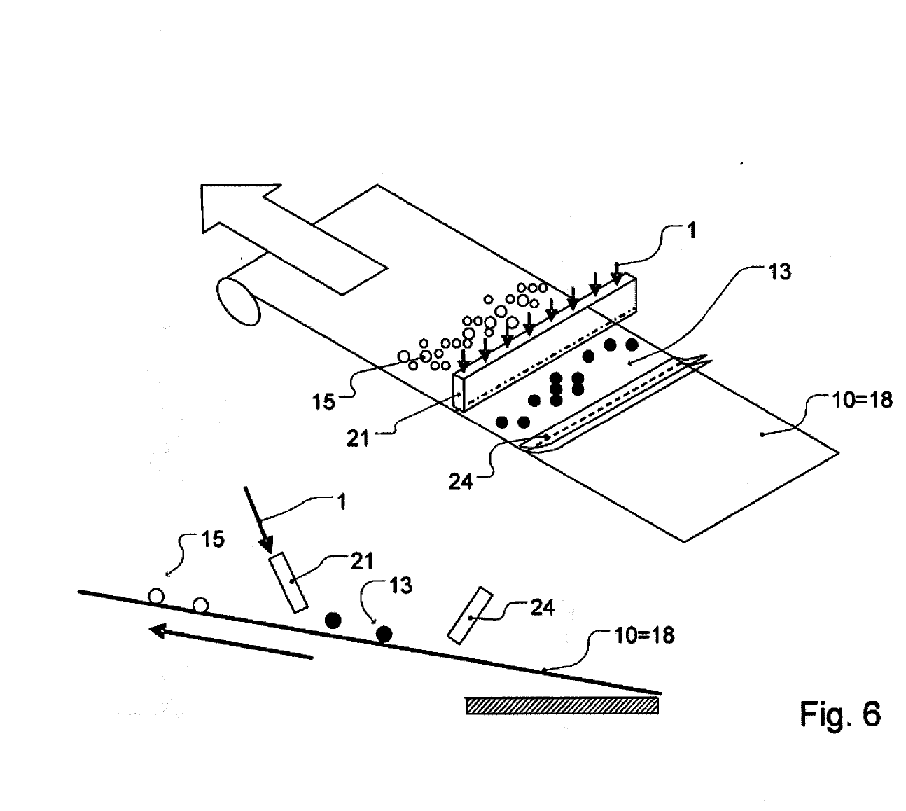

FIG. 6 is like FIG. 4, but having a revolving belt inclined in the longitudinal direction as collection electrode;

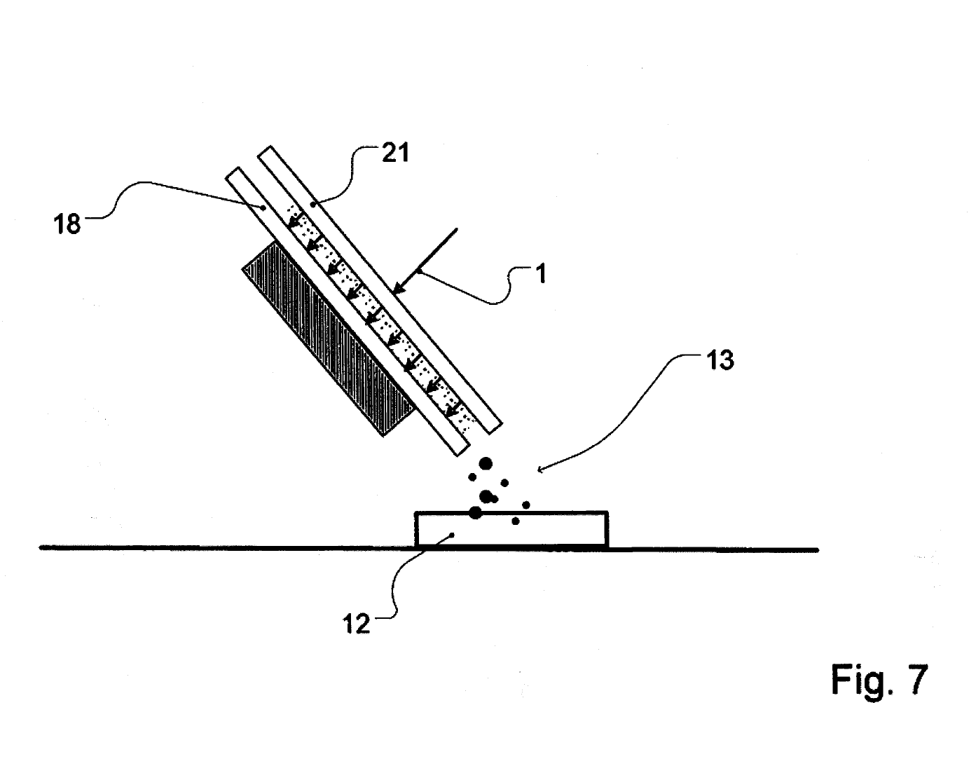

FIG. 7 is like FIG. 4, but having a revolving belt inclined in the transverse direction as collection electrode;

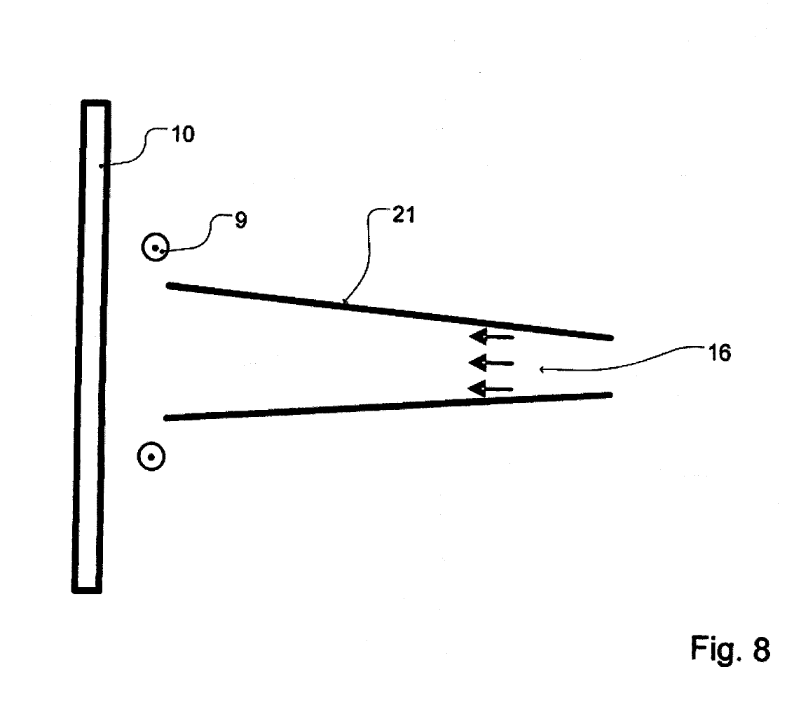

FIG. 8 shows a schematic diagram of a separation appliance with slit nozzle and corona wire at the outlet;

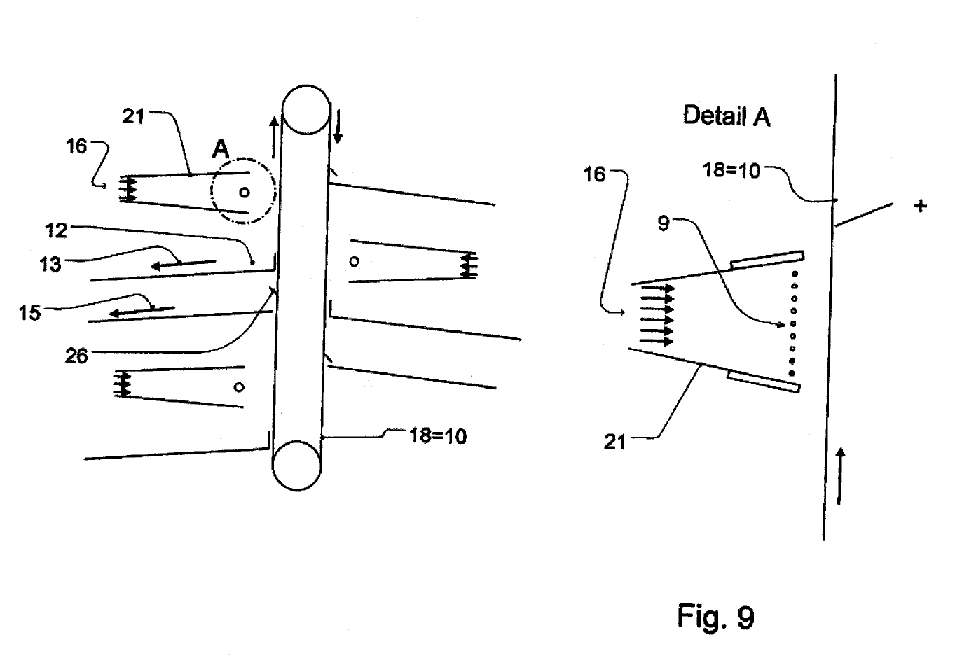

FIG. 9 is like FIG. 8, but having a revolving belt as collection electrode;

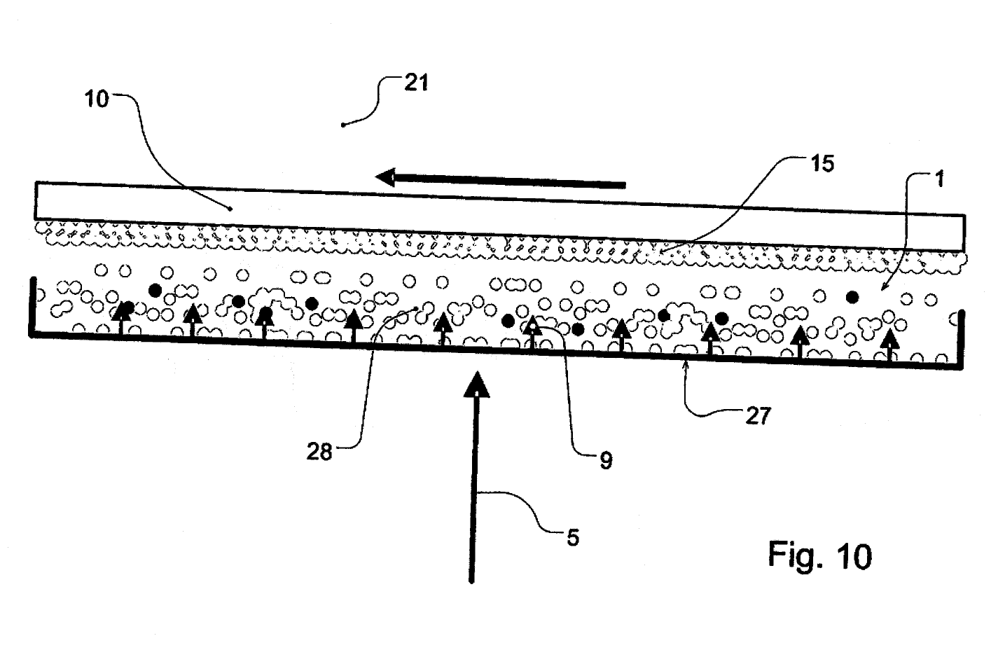

FIG. 10 shows a schematic diagram of a stationary fluidized bed;

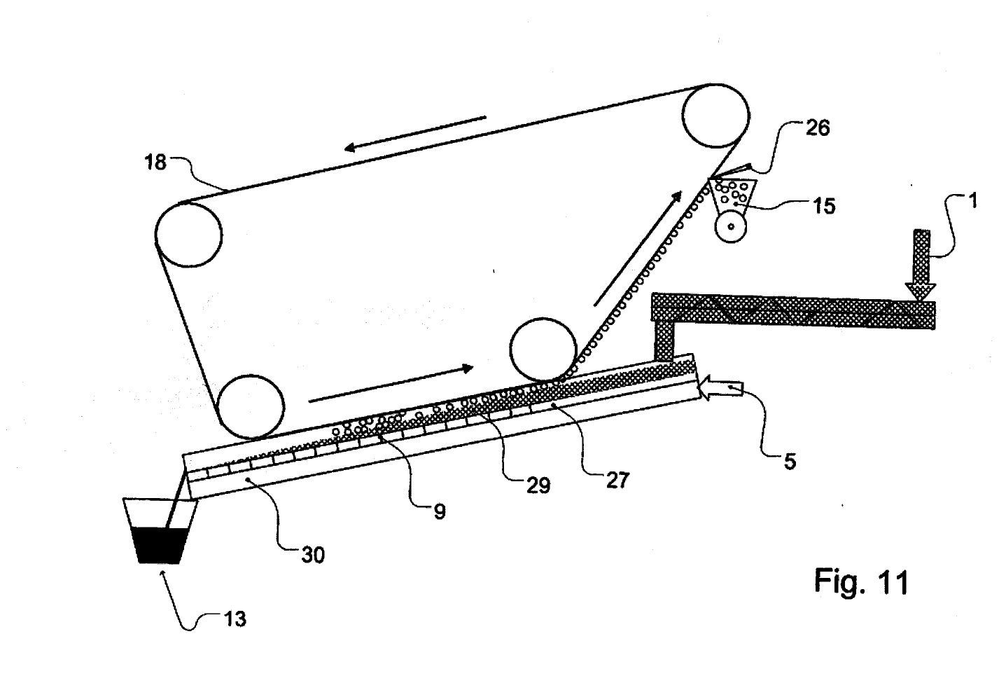

FIG. 11 shows a schematic diagram of a separation appliance with moving bed and revolving belt as collection electrode; and

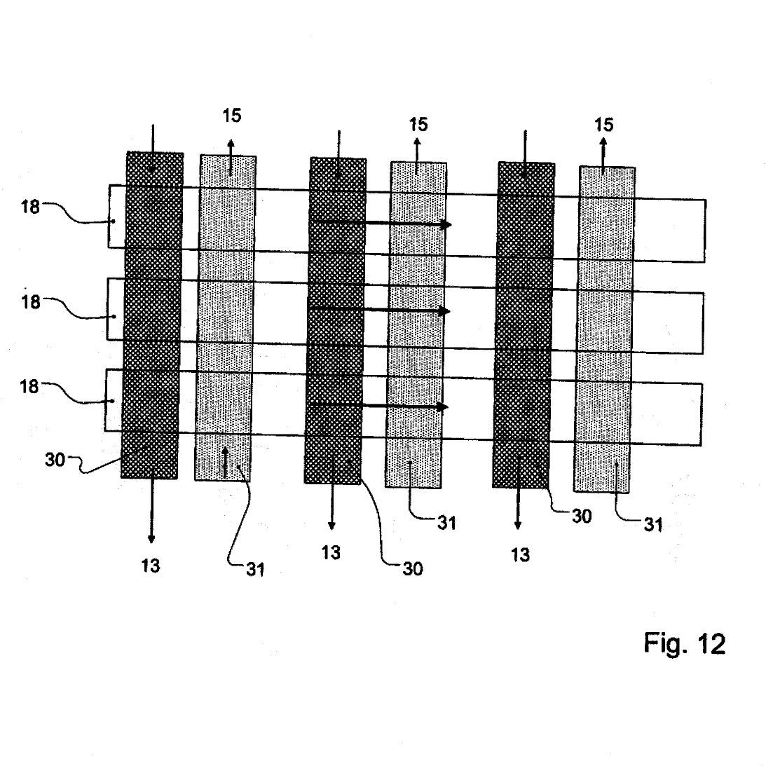

FIG. 12 shows a design variant of the separation appliance from FIG. 11 with a plurality of moving beds, belt-shaped collection electrodes and cleaning belts.

FIGS. 1 and 2 show an experimental setup for carrying out the method. A particle mixture 1 is provided in a tank 2. The tank 2 is embodied as a fluid tank and allows a fluidization of the particle mixture. The latter is composed of electrically non-conductive particles (illustrated as unfilled circle) and electrically conductive particles (illustrated as filled dot). A spraying device 3 comprises a mixing chamber 4, into which clean pressurized air 5 can be injected via a tapering nozzle 6. A suction line 7 connects the mixing chamber 4 to the tank 2. A charge line 8 is likewise connected to the mixing chamber 4 and a needle-like wire (diameter less than 1 mm) coaxially extends through the former and serves as corona electrode 9. The charge line 8 is a pipe with a circular cross section and an internal diameter of approximately 2 cm. The aforementioned dimensions relate to the laboratory scale. A separation appliance on an industrial scale is likely to have greater diameters for charge line and corona electrode. The corona electrode 9 is electrically insulated from the remaining components of the spraying device 3, in particular from the charge line 8 made of a non-conductor.

The opening of the charge line 8 is directed at a baffle plate made of a steel sheet and serving as collection electrode 10. The surface of the collection electrode is aligned rotated by approximately 90° with respect to the axis of the charge line 8 or of the corona electrode 9. The electric field lines between corona electrode 9 and collection electrode 10 consequently run parallel to the flow paths of the particles of the particle stream from the charge line 8 in the direction of the collection electrode.

A pneumatically driven hammer 11 is attached to the side of the collection electrode 10 facing away from the spraying device. Arranged below the collection electrode 10 are a first collection pan 12 for a first fraction 13 and a second collection pan 14 for a second fraction 15.

For the purposes of pneumatic conveying, pressurized air 5 is applied to the nozzle 6 at a pressure of 6 bar and a volume flow of approximately 4 m³/h. As a result of applying pressurized air through the fluid base of the tank 2, the particle mixture is already fluidized in the tank 2 such that a homogeneous mixture of particles and air is ensured. As a result of the tapering cross section of the nozzle 6, the pressurized air experiences strong acceleration up to the emergence from the nozzle 6. The pressure of the pressurized air 6 in the mixing chamber 4 sinks rapidly as a result of the widening cross section of the mixing chamber 4, and so negative pressure is produced and suctions the particle mixture 1 into the mixing chamber 4 via the suction line 7. In the mixing chamber, pressurized air 5 and particle mixture 1 mix to form a particle stream 16, which leaves the mixing chamber 4, in the direction of the collection electrode 10, through the charge line 8. First the particle stream 16 moves along the corona electrode 9, which, with −30 kV, is under high voltage, such that the air molecules and the mixture particles of the particle stream 16 are charged with negative polarity. The particle stream 16 is sprayed onto the collection electrode 10, charged to +12 kV, from the charge pipe 8 which is directed at the surface of the collection electrode 10 at an angle of approximately 90°. The free path of the particle stream 16 through the air is approximately 100 to 200 mm.

The separation occurs as soon as the negatively charged particles impinge on the grounded collection electrode 10: the electrically conductive particles (black) are repelled from the collection electrode in accordance with their angle of incidence and collect in the first collection pan 12. Meanwhile, the electrically non-conductive particles (white) adhere to the collection electrode 10.

The collection electrode 10 is occupied by non-conductive particles after a time of approximately 20 to 60 s. Now pressurized air 6 and high voltage of the corona electrode are switched off and the hammer 11 is actuated (FIG. 2). The latter applies an impulse load on the collection electrode 10 for approximately 3 s, said load releasing the second fraction from the collection electrode 10 and letting it fall into the second collection pan 14.

Now a first conductive fraction 13 of approximately 40 g is found in the first collection pan 12, while a second non-conductive fraction 15 of approximately 110 g is found in the second collection pan 14. For this yield, a collection electrode with an area of 20 by 30 cm was sprayed ten times for 20 seconds and the charge line was, in the process, moved relative to the collection electrode with unchanging electrode spacing.

As a result of suitable up scaling, in particular by increasing the amount of throughput in the spraying device 3 and continuous loading and cleaning of the collection electrode which should now be moved, it is possible to increase the separation power for large amounts of particles. It is also possible to multiply the number of charge lines by arranging a series of charge lines in the horizontal direction and a plurality of such sets in the vertical direction.

Various embodiment options of separation appliances with high throughput power should be explained in more detail below on the basis of schematic drawings.

FIG. 3 shows a continuous embodiment with a plurality of spraying stations 17 and a continuously revolving belt 18 as collection electrode. As an alternative to the belt, it is possible to provide a closed chain pull, on the limbs of which plates are arranged as collection electrodes. Each spraying station 17 comprises a multiplicity of spraying devices 3 working in parallel. The spraying devices can be embodied as described above in respect of FIG. 1 and FIG. 2. The belt 18 passes the spraying stations 17 and, in the process, flows of particles to be separated are applied thereto over a large area. The second fraction adheres to the belt 18; the first fraction is repelled, falls down and is collected in the region of the spraying station 17 (not illustrated). The belt 18 which is occupied by the second fraction proceeds to a cleaning station 19, which is cleaned by means of a hammer 11 and/or a set of brushes 20. A hammer is more suited to cleaning plate-shaped collection electrodes on a revolving chain pull; a scraper or a brush should preferably be used for cleaning a belt. The second fraction is collected in the cleaning station 19 (not illustrated). Thereupon the belt proceeds to a next spraying station 17, which in turn is followed by a cleaning station 19. The continuously revolving belt 18 is thus alternately sprayed with particles and cleaned again.

FIG. 4 shows an alternative nozzle design with an elongate slit nozzle 21. The left-hand side illustrates the frontal view; the right-hand side illustrates the side view. The particle stream 16 emerges through the slit nozzle 21. The ionization is assumed by a wire-shaped corona electrode 22, which is beset with a multiplicity of tips 23 (cf. FIG. 6a). The wire-shaped corona electrode 22 extends over the opening of the slit nozzle 21, i.e. transversely with respect to the flow direction of the particle stream 16. The particle stream 16 is directed at a collection electrode 10 in the form of a flat baffle plate extending parallel to the slit nozzle 21. Said baffle plate is cleaned by a hammer 11.

FIG. 5 shows various embodiments of wire-shaped corona electrodes beset with tips.

FIG. 6 shows how the unmoving collection electrode 10 from FIG. 4 can be replaced by a continuously revolving belt 18 in order to obtain a continuously operating separation appliance. In the perspective view top right in the image, it is possible to identify that the first fraction 13 is collected by means of a suction nozzle 24. The adhering second fraction 15 proceeds on with the belt 18 to a cleaning station (e.g. scraper of set of brushes) not illustrated here.

In the side view of the appliance illustrated bottom left in FIG. 6, it is possible to identify why the first fraction 13 moves to the suction nozzle 24 against the running direction of the belt while the adhering second fraction 15 moves along with the belt 18: the belt 18 is namely arranged with an incline in the longitudinal direction and runs upwards. The non-adhering particles 13 consequently fall downward against the movement direction of the belt 18, in the direction of the suction nozzle 24 arranged downhill.

As per FIG. 7, it is also possible for the revolving belt 18 to be inclined to the side (the belt moves into the plane of the drawing). The first fraction 13 of the particles supplied by the slit nozzle 21 falls laterally off the belt 18 and is collected.

FIG. 8 shows the side view of another design variant with slit nozzle 21. The particle stream 16 emerges from the slit nozzle 21 in the direction of the collection electrode 10. Two corona electrodes 9, embodied as wires, run transversely to the flow direction of the particle stream 16 in the direct vicinity of the slit nozzle 21. In practice, such a separation appliance can be embodied like the coating installation described in U.S. Pat. No. 7,626,602B2.

FIG. 9 shows a variant of the embodiment with slit nozzle 21 shown in FIG. 8. In this case, the collection electrode is a continuously revolving belt 18, the pull strand and the return strand of which extend in the vertical direction. A multiplicity of spraying stations 17 are provided on these, said spraying stations 17 operating with slit nozzles 21.

Detail A shows that the wire-shaped corona electrodes 9 in this case run on the outlet of the slit nozzles 21, i.e. directly in the particle stream 16. The non-adhering particles 13 are collected by means of collection pans 12 arranged below the slit nozzles 21; the belt is cleaned by scrapers 26 for the purpose of obtaining the second fraction 15.

FIGS. 10 to 12 show separation appliances which do not operate with a fluid flow emerging from a nozzle, but rather with fluidized beds.

The basics of the fluidized bed principle are shown in FIG. 10. To this end, the mixture 1 is supplied to an air-permeable but particle-tight fluid base 27. The fluid base 27 is generally a textile sheet or a porous or perforated plate. The fluid base 27 therefore has a multiplicity of air passages, respectively with a diameter of approximately 20 μm. Pressurized air 5 is applied to the fluid base 27 from below. The pressurized air 5 passes through the air passages to the particles resting on the fluid base 27 in a layer-like manner and swirls these in an unordered fashion to form a fluidized bed 28, which extends in a restricted region over the fluid base 27. Since the fluidized bed does not move its position in space and the only movement is of the particles within the fluidized bed 28, this is referred to as a stationary fluidized bed in this case.

Within the fluidized bed, the particles are dispersed (isolated) in the air, preventing agglomeration. The isolated particles around which pressurized air 5 flows can be ionized in an outstanding manner with the aid of a multiplicity of corona electrodes 9 which extend in the fluidized bed 28. The corona electrodes 9 can be arranged on the fluid base, as described in EP1321197B1, or above the fluid base, as known from DE102004010177B4. In the latter case, the ionization of the air, the fluidization of the particle mixture and the mixing of ionized air with fluidized particle mixture for the purpose of obtaining the ionized, fluidized particle mixture occur in one step.

Alternatively, it is possible to ionize and fluidize in two steps: to this end, pressurized air is first of all ionized and the ionized pressurized air is directly applied to the particles for the purposes of fluidization. In this case, the corona electrodes are arranged directly below the fluid base such that the pressurized air is ionized just before it emerges into the particle mixture from the fluid base.

The fluidized bed 28 with the multiplicity of corona electrodes 9 extending therein virtually consists of a bundled multiplicity of infinitesimally small spraying devices.

A collection electrode 10 is guided through the fluidized bed, or at least to the interface thereof, with the non-conductive particles precipitating on said electrode. In order to obtain the second fraction 15, the collection electrode is removed from the fluidized bed 28 and cleaned. The first fraction remains in the fluidized bed 28. Thus, over time, the second fraction 15 is depleted from the fluidized bed 28 such that the proportion of the electrically conductive fraction increases in the fluidized bed. The fluidized bed 28 must consequently be cleaned continuously and enriched with fresh mixture. To this end, the pressurized-air actuation is switched off after a suitable time interval, the fluid base 27 is brushed clean in order to obtain the first fraction 13 and an additional dose of fresh mixture 1 is applied. In the meantime, it is also possible to clean the collection electrode 10 in order to obtain the second fraction 15 if this does not occur on a continuous basis. The pneumatic actuation is thereupon restarted and the separation process starts anew. However, continuous operation is preferred over this batch operation.

A separation appliance working in a fully continuous fashion with a high throughput can be realized with the aid of a moving fluidized bed. A moving fluidized bed—abbreviated to moving bed—29 differs from a stationary fluidized bed 28 in that the moving bed moves as a whole. Notwithstanding, the overall movement speed of the moving bed is slow compared to the particle movement within the fluidized bed. However, compared to the flow speed of the fluid flow the moving bed moves slowly.

In the simplest case, the moving bed 29 is put into motion with the aid of gravity: to this end, provision is made for a channel 30 which is inclined at 10 to 15° with respect to the horizontal and has a fluid base 27 to which pressurized air 5 is applied from below, cf. FIG. 11. Corona electrodes are installed in the fluid base 27. Fresh particle mixture 1 is supplied at the upper end of the channel 30. The fluidized, ionized particle mixture slides down the channel 30, driven by gravity, as a moving bed 29. In the process, the second fraction 15 is precipitated on a continuously revolving belt 18, which, in sections, runs up along the channel 30, against the movement direction of the moving bed 29 and through same. The belt speed is approximately 10 km/h. The high belt speed guarantees an industrially relevant high throughput when purifying the particle mixture. In the case of an average occurrence of the non-conductive fraction of approximately 0.2 kg/m² (trial described above), a belt width of 1.5 m and a speed of 10 km/h, the calculated mass flow of the obtained non-conductive fraction is approximately 3 t/h in the case of only one moving bed. As the moving bed 29 passes through the channel 30, the second fraction is gradually depleted therefrom. Thus, conductive particles emerge from the lower end of the channel 30, which are collected as first fraction 13. The second fraction 15 is removed from the belt 18 with a scraper 26. The cleaned belt 18 returns into the moving fluidized bed 29.

FIG. 12 shows how the appliance from FIG. 11, operating with moving bed 29 and belt 18 as collection electrode, can increase its throughput by multiplying the channels and belts thereof and parallelizing these:

It is possible to identify from the plan view illustrated in FIG. 12 that a plurality of inclined channels 30 running in parallel are crossed by a plurality of belts 18 running in parallel. The metallic belts 18 serve as collection electrode and run transversely through the channels 30 and through the moving bed 29 moving therein. The belts 18 remove the non-conductive load from the moving beds in the transverse direction and are crossed by cleaning belts 31, which are arranged in alternating fashion in parallel between the inclined channels 30. Respectively one scraper is arranged in the crossing region of belt 18 and cleaning belt 31 and it clears the belt 18 of non-conductive particles and transfers the latter onto the cleaning belt 31. The continuously revolving cleaning belts 31 continuously remove the second fraction 15, while the first fraction 13 leaves the separation appliance at the lower end of the inclined channels 30.

### LIST OF REFERENCE SIGNS

1 Particle mixture

2 Tank

3 Spraying device

4 Mixing chamber

5 Pressurized air

6 Nozzle

7 Suction line

8 Charge line

9 Corona electrode

10 Collection electrode

11 Hammer

12 First collection pan (for the first fraction)

13 First fraction

14 Second collection pan (for the second fraction)

15 Second fraction

16 Particle stream

17 Spraying station

18 Belt as collection electrode

19 Cleaning station

20 Set of brushes

21 Slit nozzle

22 Plate-shaped corona electrode

23 Tips

24 Suction nozzle

26 Scraper

27 Fluid base

28 (Stationary) fluidized bed

29 Moving fluidized bed/moving bed

30 Channel

31 Cleaning belt

1. A method for separating particle mixtures into a first fraction and second fraction, wherein the electrical conductivity of the particles of the first fraction is greater than the electrical conductivity of the second fraction, the method comprising:
a) ionizing air to have the same polarity with a corona electrode surrounded by air to be ionized;
b) mixing the ionized air with a fluidized particle mixture comprising two particle fractions with differing electrical conductivity, to obtain a fluidized particle mixture ionized to have the same polarity;
c) precipitating particles of the second fraction from the ionized, fluidized particle mixture on a collection electrode which is moving relative to the ionized, fluidized particle mixture and which is grounded or has an opposite charge to the corona electrode;
d) removing particles adhering to the collection electrode, thereby obtaining the second fraction; and
e) obtaining the first fraction from particles of the ionized, fluidized particle mixture which do not adhere to the collection electrode.

2. The method of claim 1, wherein an airflow force is applied to the fluidized particle mixture prior to or after the ionization, and the particle mixture is supplied as a fluid flow in the direction of the moving or unmoving collection electrode.

3. The method of claim 2, wherein the ionization takes place in a charge line through which the fluid flow is routed and in which the corona electrode extends,
wherein the ionized fluid flow emerging from the charge line is directed at a collection electrode, and
wherein the particles rebounding from the collection electrode are collected as the first fraction and the particles adhering to the collection electrode are removed from the collection electrode as the second fraction.

4. The method of claim 3, wherein the charge line is a pipe comprising an electrically insulating material, through which the corona electrode, which is embodied as a wire, extends in a coaxial fashion.

5. The method of claim 3, wherein the charge line is a slit nozzle comprising an electrically insulating material, over the cross section of which a wire-shaped corona electrode beset with tips extends.

6. The method of claim 4, wherein the airflow force for generating the fluid flow is applied to the fluidized particle mixture such that inflowing pressurized air is injected through a tapering nozzle into a mixing chamber connected firstly to the charge line and secondly to a tank which provides the fluidized particle mixture, the flow cross section of which mixing chamber being greater than the opening cross section of the nozzle.

7. The method of claim 2, wherein the fluid flow emerges through a slit nozzle comprising electrically insulating material, in the surroundings of which a corona electrode in the form of a wire extending transversely with respect to the fluid flow is arranged such that the fluid flow is ionized when the third flow emerges from the slit nozzle, and
wherein the ionized fluid flow which has emerged from the slit nozzle is directed at a collection electrode, wherein the particles rebounding from the collection electrode are collected as the first fraction and the particles adhering to the collection electrode are removed from the collection electrode as the second fraction.

8. The method of claim 2, wherein the collection electrode is a stationary baffle plate.

9. The method of claim 2, wherein the collection electrode is a revolving belt or a multiplicity of plates attached to a revolving chain.

10. The method of claim 3, wherein the ionized fluid flow is directed at the collection electrode such that the ionized fluid flow impinges on the surface of the collection electrode at an angle that differs from 180°.

11. The method of claim 1, wherein the fluidized particle mixture is a stationary fluidized bed,
wherein the collection electrode is a rotating drum or a revolving belt, the drum or the belt is immersed into or at least contacts the fluidized, ionized particle mixture in sections, and
wherein the second fraction is removed from the belt or drum outside of the immersed or contacted region.

12. The method of claim 11, wherein a pneumatic loading of a stationary fluidized bed is interrupted intermittently, and during the interruption, particles of a collapsed fluidized bed are collected as the first fraction and replaced by a further particle mixture comprising two particle fractions with differing electrical conductivity.

13. The method of claim 1, wherein the fluidized particle mixture is a moving fluidized bed and the collection electrode is a rotating drum or a revolving belt, with the fluidized bed moving along a section of the drum or of the belt.

14. The method of claim 13, wherein an airflow force is applied to the fluidized bed, thereby setting the fluidized bed into migratory motion in the direction of the collection electrode.

15. The method of claim 13, wherein the fluidized bed moves through an inclined channel, at an upper end of which the particle mixture to be separated is provided and at a lower end of which the first fraction is collected, and
wherein the collection electrode is embodied as a revolving belt, which, in one section, travels through the channel in the same direction as or counter to the moving fluidized bed and which, outside of the section, is cleaned of adhering particles in order to obtain the second fraction.

16. The method of claim 13, wherein the fluidized bed moves through an inclined channel, at an upper end of which the particle mixture to be separated is provided and at a lower end of which the first fraction is collected, and
wherein the collection electrode is embodied as a revolving belt, which, in one section, travels through the channel transversely to the moving fluidized bed and which, outside of the section, is cleaned of adhering particles in order to obtain the second fraction.

17. The method of claim 1, wherein the corona electrode has a negative electric charge and the collection electrode is grounded or has a positive electric charge.

18. The method of claim 1, wherein the particles adhering to the collection electrode are removed as the second fraction by applying an impulse load on the collection electrode.

19. The method of claim 1, wherein the particles adhering to the collection electrode are removed as the second fraction by scraping.

20. The method of claim 1, wherein the particle mixture is subjected to a mechanical screening process prior to fluidization, and a screen utilized for the screening is excited by an ultrasound oscillation in the range between 20 and 27 kHz.

21. The method of claim 1, wherein the particle mixture is pulverized electrical scrap.

22. The method of claim 21, wherein the electrical scrap comprises a photovoltaic element.

23. The method of claim 21, wherein the electrical scrap comprises an electrode from an electrochemical cell.

24. A method for separating electrical scrap, the method comprising:
a) grinding electrical scrap to a grain size of less than 100 μm, to obtain pulverized electrical scrap;
b) pneumatic loading of the pulverized electrical scrap, to obtain a fluidized particle mixture; and
c) carrying out the separation method of claim 1.

25. An appliance comprising:
a) an inclined channel comprising an air-permeable base to which pressurized air is applied and which comprises a multiplicity of corona electrodes;
b) a metering apparatus arranged at an upper end of the inclined channel, wherein the metering apparatus supplies a particle mixture comprising a first fraction and a second fraction, wherein the electrical conductivity of the particles of the first fraction is greater than that of the second fraction to the inclined channel;
c) a collector that collects the first fraction, arranged at the lower end of the inclined channel;
d) a revolving runner that runs in the inclined channel in sections; and
e) a scraper arranged on the runner outside of the inclined channel, that scrapes off particles adhering to the runner as the second fraction.

26. The appliance of claim 25, wherein the runner is embodied as a belt and the revolving belt runs up the inclined channel along the inclined channel.

27. The appliance of claim 25, comprising a multiplicity of runners which run transversely through the inclined channel and are respectively embodied as a belt; and
a revolving cleaning belt which runs parallel to the inclined channel,
wherein scrapers are provided in a crossing region of cleaning belt and runners, which scrapers clean off particles adhering to the runners as the second fraction and supply said particles to the cleaning belt to be transported away.

28. The method of claim 1, wherein the particle size of the first and the second fractions is less than 100 μm.
